(19) United States
(12) Patent Application Publication
(10) Pub. No.: US 2004/0063562 A1
(43) Pub. Date: Apr. 1, 2004

(54) Centrifuge

(76) Inventors: Jochen Hamatschek, Oelde (DE); Willi Niemerg, Oelde (DE); Wilfried Mackel, Oelde (DE)

Correspondence Address: BARNES & THORNBURG, 750-17TH STREET NW, SUITE 900, WASHINGTON, DC, 20006, US

(21) Appl. No.: 10/466,676

(22) PCT Filed: Jan. 8, 2002
(86) PCT No.: PCT/EP02/00080

(30) Foreign Application Priority Data
Jan. 27, 2001 (DE) 101 03 769.4

(51) Int. Cl. B04B 9/14

(52) U.S. Cl. 494/82

(57) ABSTRACT

A centrifuge that includes a centrifugal drum having a solids collecting chamber arranged below a bottom of the centrifugal drum. Also included is an oscillation measuring device for recording oscillations of the centrifugal drum. Further included is a medium situated in the solids collecting chamber. Also included is at least one feeler element that protrudes beyond the bottom of, and is connected to the centrifugal drum. When the medium level rises in the solids collecting chamber, the at least one feeler element is contacted by the medium before the medium contacts the centrifugal drum. The contact results in uncritical oscillations that are analyzed by the oscillation measuring device.

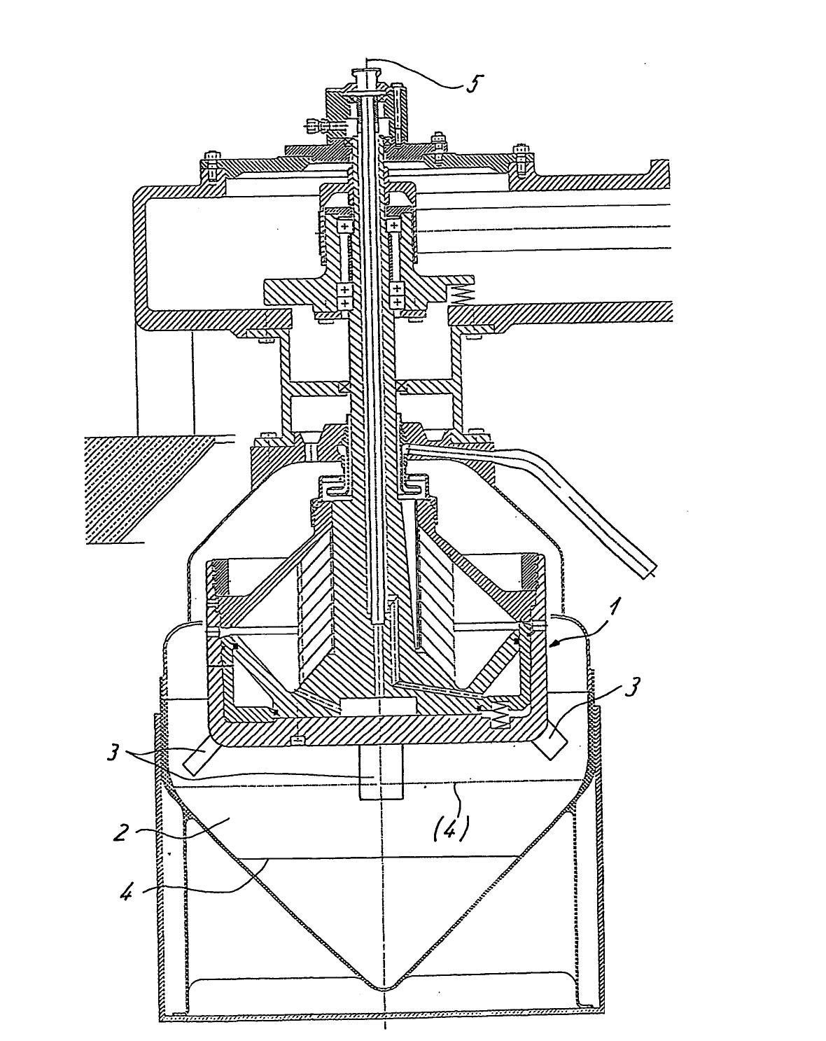

The present invention relates to a centrifuge having a centrifugal drum, a solids collecting chamber arranged below the centrifugal drum, and having an oscillation measuring device for recording oscillations of the centrifugal drum.

Centrifuges of the above-mentioned type are known per se.

In the case of centrifuges of this type, the oscillation measuring device can record and analyze oscillations caused by the centrifugal drum, in which case, based on the determined results, as an alternative, a change of the operating parameters and, if required, even a switching-off of the centrifuge will then be caused in order to avoid damage. Likewise, a warning signal can be activated by which the operating personnel is caused to check a centrifuge which obviously is no longer running under optimal operating conditions.

If the level in the solids collecting chamber has risen to such an extent that the centrifugal drum itself comes in contact with the filled-in medium in the solids collecting tank, oscillations of an unacceptable intensity and strength may occur within a very short time. In the worst case, these oscillations may result in damage to the centrifuge because, under certain circumstances, the reaction times of the oscillation measuring device and of the control devices which follow may not be sufficient for preventing such damage.

The present invention is based on the object of further developing a centrifuge of the above-mentioned type such that the occurrence of oscillations of an unacceptable intensity and strength because of a contact of the centrifugal drum with the medium filled in the solids collecting chamber can be reliably avoided.

According to the invention, this object is achieved in that at least one feeler element or tentacle, which protrudes beyond the lowest plane of the centrifugal drum, is fastened to the centrifugal drum. When the level in the solids collecting chamber rises, this feeler element is contacted first with the medium situated in the solids collecting chamber so that, before the centrifugal drum is contacted by the medium, uncritical oscillations are generated which are recorded and analyzed by the oscillation measuring device.

As a result of this measure, which has a relatively simple construction and is cost-effective with respect to manufacturing aspects, it is ensured that, clearly before a contacting between the centrifugal drum and medium collected in the solids collecting chamber, oscillations of an absolutely uncritical intensity are generated which can be recorded and analyzed by the oscillation measuring device, so that major damage, as may occur during oscillations of an unacceptable intensity or strength, is avoided.

Additional characteristics of the invention are the object of subclaims.

The attached drawing shows an embodiment of the invention which will be described in detail in the following.

The single FIGURE is a sectional view of a centrifuge according to the invention.

The centrifuge illustrated in the sectional representation of the drawing is equipped with a centrifugal drum 1 which at least partially projects into a solids collecting chamber 2 arranged below the centrifugal drum 1.

In addition, the centrifuge is equipped in a manner known per se with an arbitrary and therefore not shown oscillation measuring device for recording oscillations of the centrifugal drum 1.

According to the invention, at least one feeler element 3, which protrudes beyond the lowest plane of the centrifugal drum 1, is fastened to the centrifugal drum, which feeler element 3, when the level in the solids collecting chamber rises (as indicated by the dash-dotted line), is contacted first with the medium 4 situated in the solids collecting chamber 2. If this occurs, slight uncritical oscillations are generated which can be recorded and analyzed by the oscillation measuring device.

As an example, it is outlined in the drawing that a feeler element 3 may be arranged in the axis of rotation 5 of the centrifugal drum 1. The drawing also illustrates that additional feeler elements 3 may also be arranged outside the axis of rotation 5 of the centrifugal drum 1.

Here, the possibility exists of arranging several feeler elements 3 on a common graduated circle. Likewise, it is possible to arrange several feeler elements 3 of different dimensions on different graduated circles such that no unbalanced mass is thereby created.

The feeler elements 3 may have the shape of cylindrical pins. However, the feeler elements 3 may also have other geometrical cross-sectional shapes.

The feeler elements 3 may definitely be selected as a function of the product; thus, as a function of the respective medium 4.

It is decisive that, as a result of one or several feeler elements 3 on the underside of the centrifugal drum 1, the possibility is implemented of bringing these feeler elements 3 in contact before the centrifugal drum with the medium 4 rising in the solids collecting chamber 2 and thereby generate oscillations in the uncritical range which can be recorded and correspondingly analyzed by the oscillation measuring device of the centrifuge.

Any known and suitable oscillation measuring device can be used as the oscillation measuring device.

The term “oscillations” used in the above description naturally also applies to vibrations.

1. Centrifuge having a centrifugal drum, a solids collecting chamber arranged below the centrifugal drum, and having an oscillation measuring device for recording oscillations of the centrifugal drum,
characterized in that at least one feeler element (3), which protrudes beyond the lowest plane of the centrifugal drum, is fastened to the centrifugal drum (1), which feeler element (3), when the level in the solids collecting chamber (2) rises, is contacted first with the medium (4) situated in the solids collecting chamber (2) so that, before the contacting of the centrifugal drum (1) by means of the medium (4), uncritical oscillations are generated which can be recorded and analyzed by the oscillation measuring device.

2. Centrifuge according to claim 1,
characterized in that a feeler element (3) is arranged in the axis of rotation (5) of the centrifugal drum (2).

3. Centrifuge according to claim 1,
characterized in that two or several feeler elements (3) are arranged outside the axis of rotation (5) of the centrifugal drum (2).

4. Centrifuge according to claim 3,
characterized in that several feeler elements (3) of different dimensions are arranged on different graduated circles of the centrifugal drum (1) which avoid unbalanced masses.

5. Centrifuge according to one or several of the preceding claims,
characterized in that the feeler element or feeler elements (3) have the shape of cylindrical pins.

6. Centrifuge according to one or several of claims 1 to 4,
characterized in that the feeler elements (3) have the shape of pins with noncircular cross-sections.
